(19) United States
(12) Patent Application Publication
(10) Pub. No.: US 2024/0144116 A1
(43) Pub. Date: May 2, 2024

(54) APPARATUS, METHOD AND COMPUTER READABLE STORAGE MEDIUM FOR GROUPING WORK REQUEST CONTENTS SELECTED FROM A WORK REQUEST CONTENT LIST

(71) Applicant: SAMSUNG SDS CO., LTD., Seoul (KR)

(72) Inventors: Daekyoung HAN, Seoul (KR); Kwangho JUNG, Seoul (KR); Boyoung CHOI, Seoul (KR); Ahram LEE, Seoul (KR); Juhee LEE, Seoul (KR); Dayeon KANG, Seoul (KR); Hyunmin LEE, Seoul (KR); Sungyun JO, Seoul (KR)

(73) Assignee: SAMSUNG SDS CO., LTD., Seoul (KR)

(21) Appl. No.: 18/492,271

(22) Filed: Oct. 23, 2023

(30) Foreign Application Priority Data
Oct. 28, 2022 (KR) 10-2022-0141772

(51) Int. Cl. G06Q 10/0631

(52) U.S. Cl. CPC G06Q 10/06311

(57) ABSTRACT

An apparatus for grouping work request contents selected from a work request content list including one or more processors and a memory storing instructions, an execution of the instructions configuring the one or more processors to display a work request content list, the work request content list including work request contents associated with a function for requesting handling by a user are enumerated, receive a user selection of two or more work request contents from among a plurality of work request contents enumerated in the displayed work request content list, and group two or more selected work request contents according to a classification criteria.

### CROSS-REFERENCE TO RELATED APPLICATION(S)

This application claims the benefit under 35 USC § 119(a) of Korean Patent Application No. 10-2022-0141772, filed on Oct. 28, 2022 in the Korean Intellectual Property Office, the entire disclosure of which is incorporated herein by reference for all purposes.

### BACKGROUND

### 1. Field

The present disclosure relates to a method, apparatus, and storage medium for grouping work requests selected from a work request content list.

### 2. Description of the Related Art

Example embodiments in the example embodiment relate to an apparatus, a method and a computer readable storage medium for grouping work request contents selected from a work request content list.

Generally, to find a desired object among many objects received from a device, a user may sort the objects included in a list by a fixed criteria, for example, by date, using a sorting function, and contents may be identified by clicking on the objects sorted by date.

Particularly, when the above-mentioned object is work request contents including a function for requesting handling by a user, the user may need to individually check the work request contents enumerated in a list and may handle each of the work request contents. Also, when work request contents, which may need to be handled in the same manner, are scattered, the corresponding work request contents may need to be searched for and handled one by one such that work efficiency may deteriorate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an apparatus for grouping work request contents selected from a work request content list, the apparatus including one or more processors and a memory storing instructions, an execution of the instructions configuring the one or more processors to display a work request content list, the work request content list including work request contents associated with a function for requesting handling by a user are enumerated, receive a user selection of two or more work request contents from among a plurality of work request contents enumerated in the displayed work request content list, and group two or more selected work request contents according to a classification criteria.

The one or more processors are further configured to extract classification criteria from each of two or more of the selected work request contents and group two or more work request contents having a same classification criteria into a group based on the extracted classification criteria.

The classification criteria includes a type of function.

The type of the function may be one or more of a first function for transmitting a handling result for the work request contents, a second function for moving to a page to enter information or to correct previously entered information, and a third function for a detailed search with respect to the work request contents.

The function may be implemented in a form of a button.

The one or more processors nay be further configured to collectively transmit handling results for two or more work request contents of the first function when the first function is performed.

The one or more processors nay be further configured to display the classification criteria and two or more work request contents having a same classification criteria in a form of user interface (UI) card with respect to groups of selected work request content.

In a general aspect, here is provided a method for grouping work request contents selected from a work request content list including displaying a work request content list including work request contents associated with a function for requesting handling by a user are enumerated, receiving a selection of two or more work request contents from among a plurality of work request contents enumerated in the displayed work request content list, and grouping two or more selected work request contents according to a classification criteria.

The grouping may include extracting the classification criteria from each of two or more selected work request contents by a classification criteria extraction portion, and

grouping two or more work request contents having a same classification criteria into a group based on the extracted classification criteria by a grouping portion.

The classification criteria may be a type of the function.

The type of the function may be one or more of a first function for transmitting a handling result for work request contents, a second function for moving to a page to enter information or to correct previously entered information, and a third function for a detailed search with respect to work request contents.

The first function, the second function, and the third function may be implemented in a form of a button.

The method may include collectively transmitting handling results for two or more work request contents of the first function when the first function is performed.

The method may include displaying the classification criteria and two or more work request contents having a same classification criteria in a form of user Interface (UI) card with respect to groups of selected work request content.

In a general aspect, here is provided a processor-implemented method including displaying a work request content list associated with a request to handle function of a plurality of functions, receiving a selection of two or more work requests from the displaying of work requests in the work request content list, and combining respective work requests of the selected two or more work requests according to a classification criteria.

The plurality of functions may be first functions for transmitting a handling result of the work request, second functions for editing information of the work request, and third functions for searching of the work request.

The first functions may include a receipt request function, an approval function, and a meeting accepted function.

The method may include displaying respective groups of the combined respective work requests with a respective criteria for the respective group.

The method may include extracting the classification criteria from the selection of two or more work requests.

The combining may include forming groups of work requests based on a shared extracted classification criteria from the extracting.

### BRIEF DESCRIPTION OF DRAWINGS

FIG. 1 is a diagram illustrating an apparatus for grouping work request contents selected from a work request content list according to an example embodiment of the present disclosure;

FIGS. 2A-2E are diagrams illustrating processing of work request contents including a process of grouping when the work request contents is logistics according to an example embodiment of the present disclosure;

FIGS. 3A-3E are diagrams illustrating processing of work request contents including a process of grouping work request contents according to an example embodiment of the present disclosure;

FIGS. 4A-4C are diagrams illustrating processing of work request contents including a process of grouping when work request contents is an email according to an example embodiment of the present disclosure;

FIG. 5 is a flowchart illustrating a method for grouping work request contents selected from a work request content list according to an example embodiment of the present disclosure;

FIG. 6 is a flowchart illustrating operation 503 in FIG. 5; and

FIG. 7 is a block diagram illustrating a computer apparatus which may fully or partially implement an apparatus for grouping work request contents selected from a work request content list according to an example embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

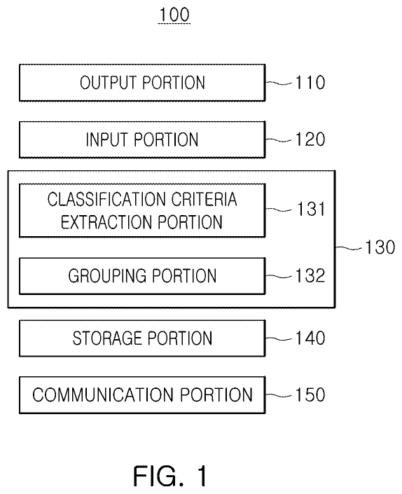

FIG. 1 is a diagram illustrating an apparatus for grouping work request contents selected from a work request content list according to an example embodiment. The apparatus 100 may include an output portion 110, an input portion 120, a controller 130, a storage portion 140, and a communication portion 150. The controller 130 may include a classification criteria extraction portion 131 and a grouping portion 132.

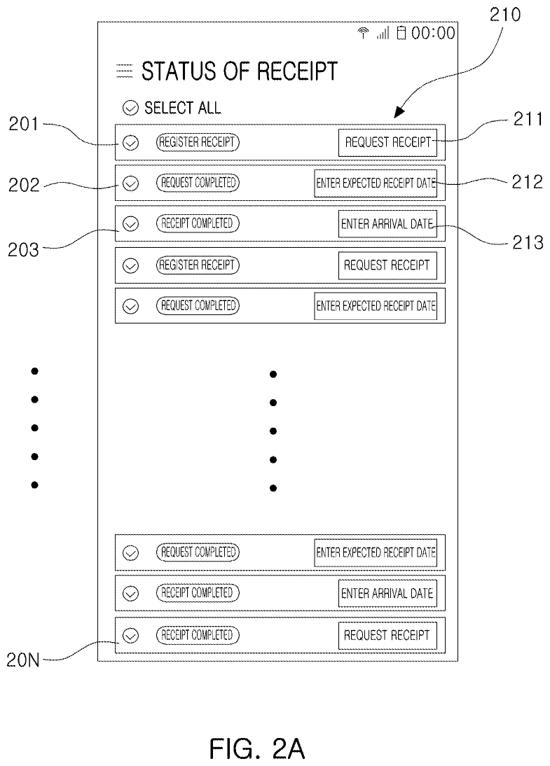

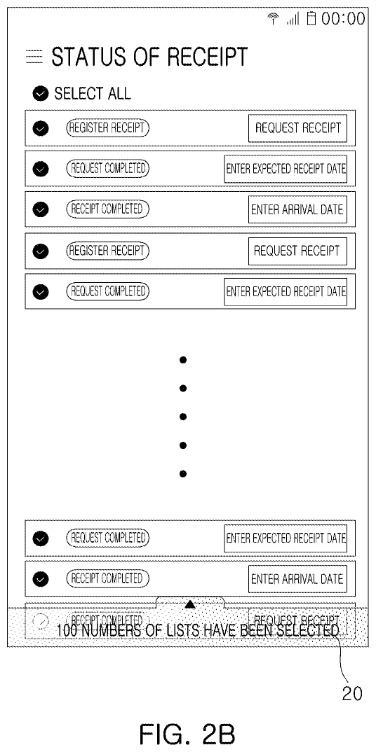

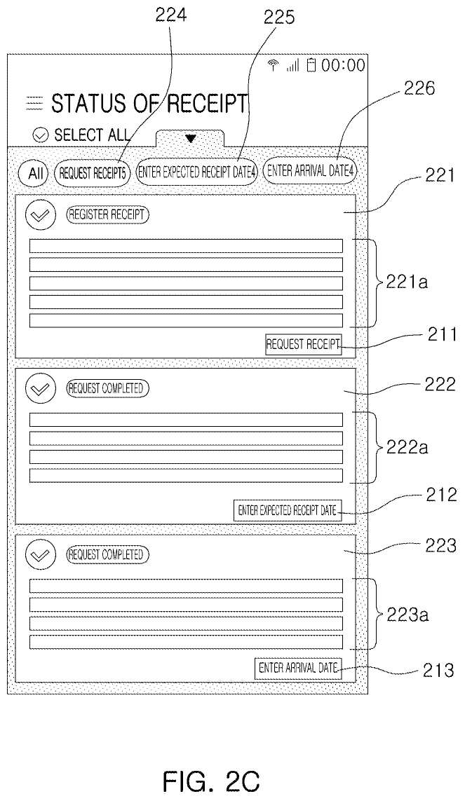

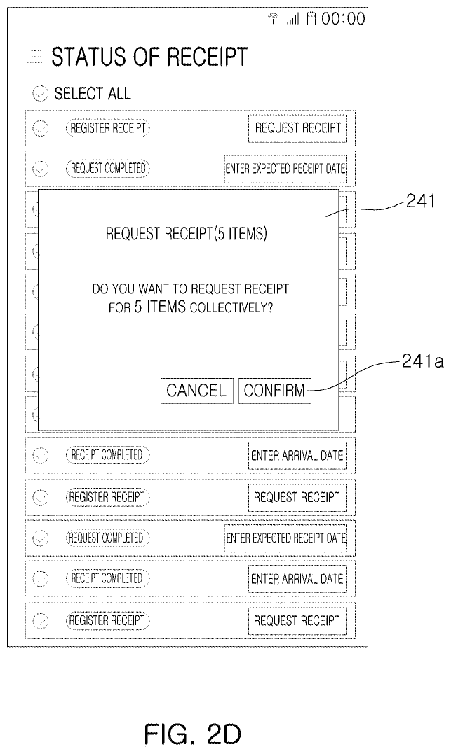

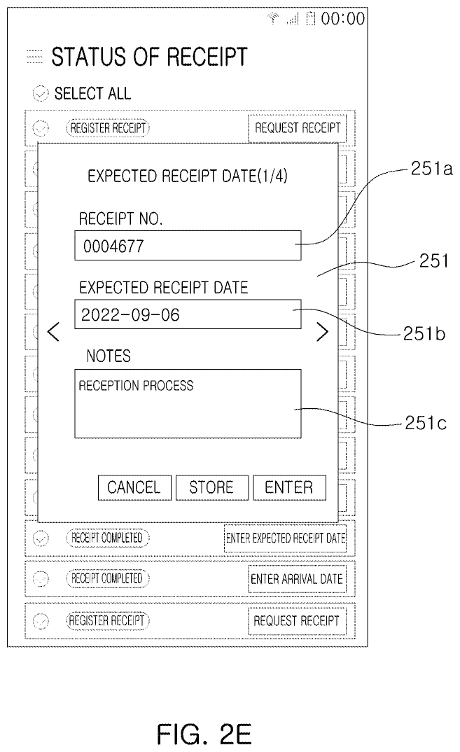

FIGS. 2A-2E are diagrams illustrating processing of work request contents including a process of grouping when the work request contents are logistics according to an example embodiment.

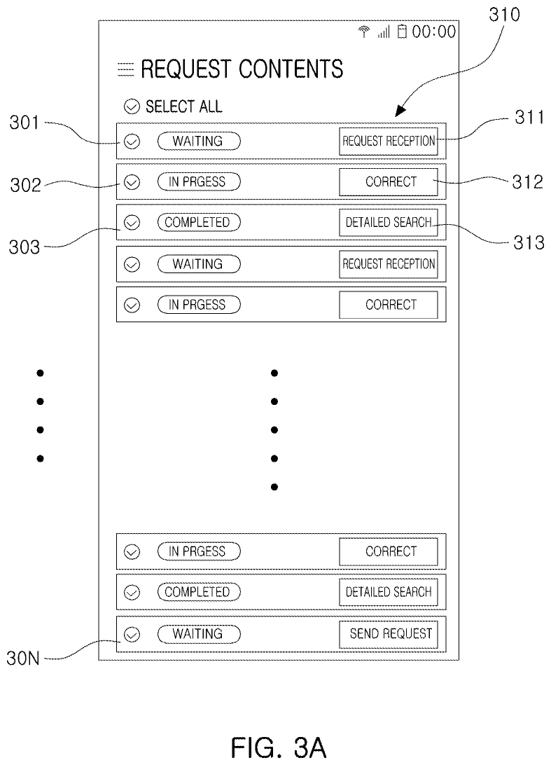

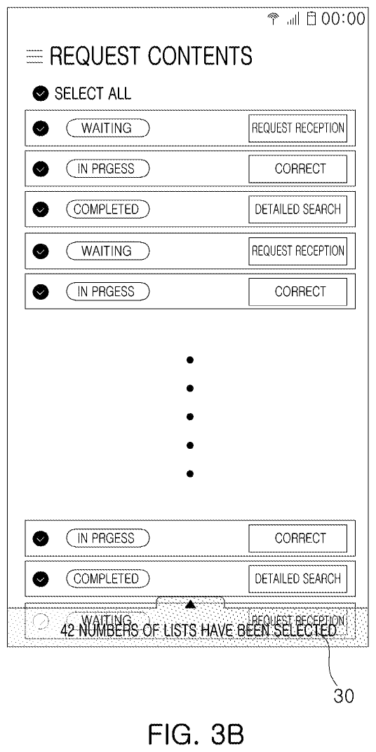

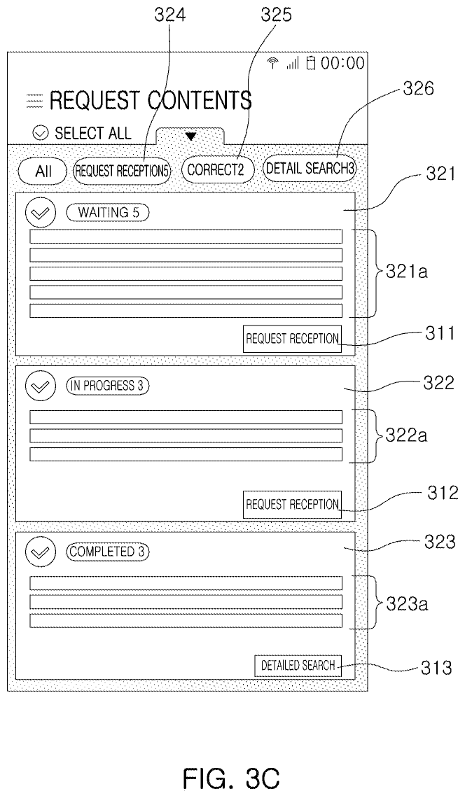

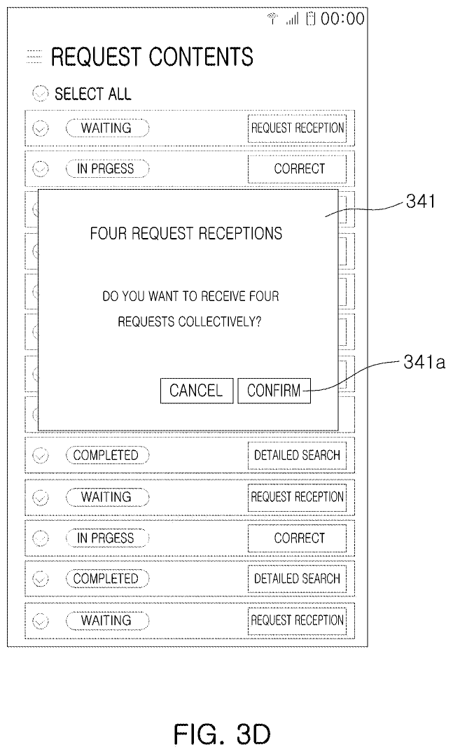

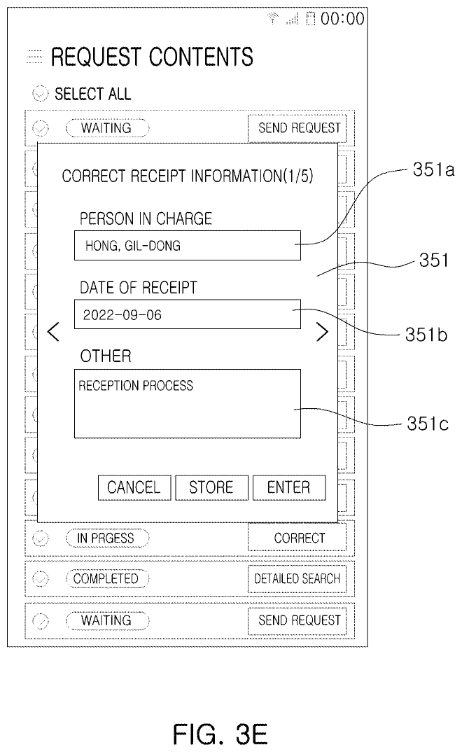

FIGS. 3A-3E are diagrams illustrating processing of work request contents including a process of grouping work request contents according to an example embodiment.

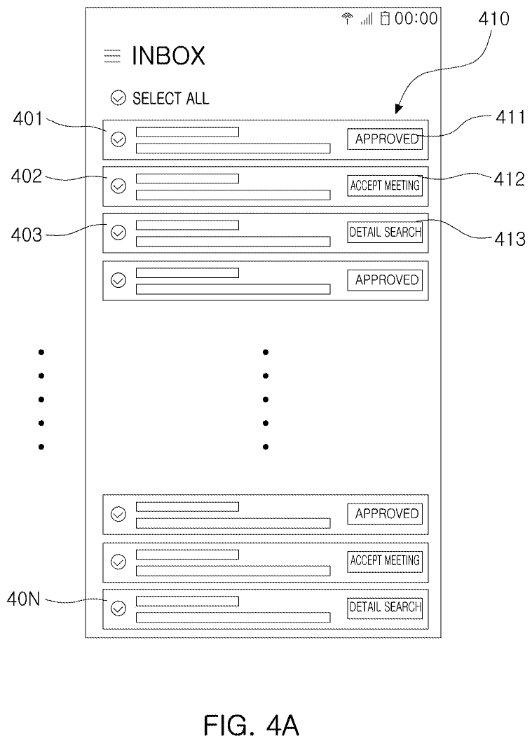

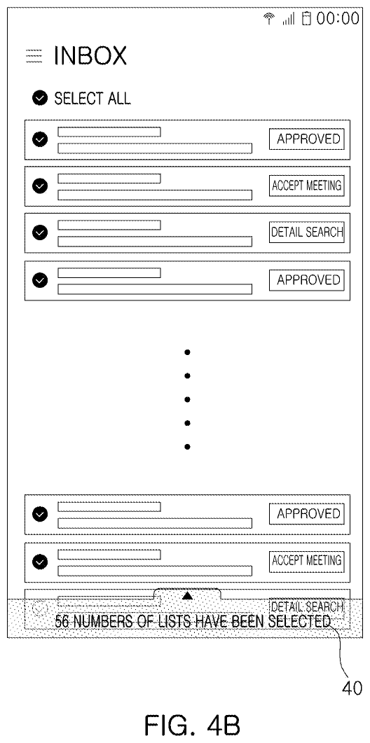

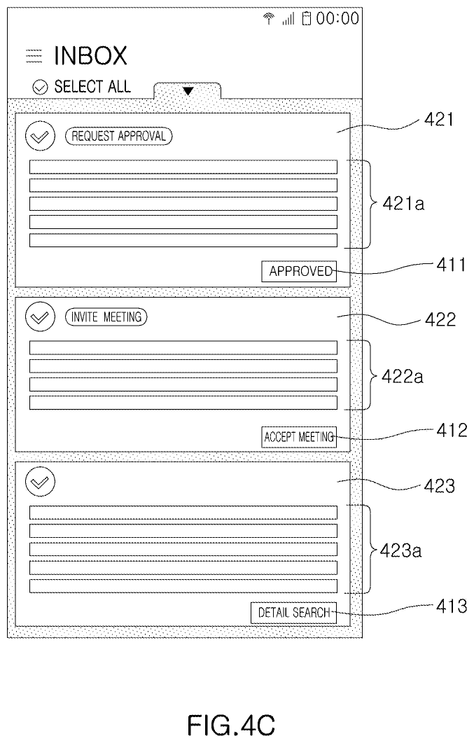

FIGS. 4A-4C are diagrams illustrating processing of work request contents including a process of grouping when work request contents is an email according to an example embodiment.

Hereinafter, an operation of the apparatus 100 for grouping work request contents selected from a work request content list according to an example embodiment will be described with reference to FIGS. 1-4C.

In describing an example embodiment, work request contents may refer to the content of a task to be handled by a user. The work request list may refer to a list enumerating the above-mentioned work request contents.

The work request contents may be sent from various business systems such as an enterprise resource planning (ERP) system, a product lifecycle management (PLM) system, and a customer relationship management (CRM) system.

Hereinafter, work request contents and functions of work request contents will be described.

For example, work request contents 201 to 20N for a status of receipt may include a receipt request function, an expected receipt date input function, and an arrival date input function, as illustrated in FIG. 2A. Here, the receipt request function may be implemented as a button 211, the expected receipt date input function may be implemented as a button 212, and the arrival date input function may be implemented as a button 213.

Work request contents 301 to 30N for a work to be done may include a request reception function, a correction function, and a detailed search function, as illustrated in FIG. 3A. Similarly, a request reception function may be implemented as a button 311, a correction function may be implemented as a button 312, and a detailed search function may be implemented as a button 313.

Work request contents 401 to 40N for an email may include an approval function, a meeting acceptance function, and a detailed search function, as illustrated in FIG. 4A. Similarly, the approval function may be implemented as a button 411, the meeting acceptance function may be implemented as a button 412, and the detailed search function may be implemented as a button 413.

Also, the above-described functions 211 to 213, 311 to 313, and 411 to 413 may be classified as one of a first function for collectively transmitting handling results for work request contents, a second function for moving to a page to enter information or to correct previously entered information, and a third function for detailed search with respect to work request contents.

For example, the first function may include the receipt request function illustrated in FIG. 2A, the request reception function illustrated in FIG. 3A, the approval function illustrated in FIG. 4A, and the meeting acceptance function. When the buttons 211, 311, 411, and 412 to implement the above-mentioned first function are clicked, handling results for work request contents may be transmitted collectively. The buttons 211, 311, 411, and 412 for implementing the first function may be referred to as first buttons.

Also, the second function may include an expected receipt date input function, an arrival date input function illustrated in FIG. 2A, and a correction function illustrated in FIG. 3A. When the buttons 212, 213, and 312 for implementing the above-mentioned second function are clicked, a page may move to a page to enter information or to correct previously entered information. The buttons 212, 213, and 312 for implementing the second function may be referred to as a second button. The above-described first button and the second button may be interlocked with a business system.

Also, the third function may include a detailed search function illustrated in FIG. 3A and a detailed search function illustrated in FIG. 4A. When the buttons 313 and 413 are clicked to implement the above-mentioned third function, detailed search with respect to work request contents may be performed. The buttons 313 and 413 for implementing the third function may be referred to as a second button.

It should be noted that the above-described work request contents and the function for the work request contents are not limited to the above-described specific items.

Referring back to FIG. 1, an output portion 110 may display a work request content list in which work request contents having a function for requesting handling by a user are enumerated. The work request content list in which the above-described work request contents are enumerated may be previously stored in the storage portion 140 described later.

Specifically, as for a status of receipt, the output portion 110 may display a work request content list 210 in which the work request contents 201 to 20N including the buttons 211 to 213 requesting handling by a user are enumerated as illustrated in FIG. 2A.

Alternatively, as for a work to be done, the output portion 110 may display a work request content list 310 in which the work request contents 301 to 30N including the buttons 311 to 313 requesting handling by a user are enumerated as illustrated in FIG. 3A.

As for an email box, the output portion 110 may display a work request content list 410 in which work request the contents 401 to 40N including the buttons 411 to 413 requesting handling by a user are enumerated as illustrated in FIG. 4A.

The above-described output portion 110 may include, for example, a display apparatus.

The input portion 120 may receive at least two or more work request contents selected by a user from among a plurality of work request contents enumerated in the work request content list displayed on the output portion 110. The selected two or more work request contents may be transferred to the controller 130 described later.

Specifically, as for a status of receipt, the output portion 110 may receive at least two or more work request contents selected by a user from among the plurality of work request contents enumerated in the displayed work request content list as illustrated in FIG. 2B. In this case, the number of selected lists may be displayed (see 20).

Similarly, as for a work to be done, the output portion 110 may receive at least two or more work request contents selected by a user from among the plurality of work request contents enumerated in the displayed work request content list as illustrated in FIG. 3B. In this case, the number of selected lists may be displayed (see 30).

Also, as for an email box, the output portion 110 may receive at least two or more work request contents selected by a user from among the plurality of work request contents enumerated in the displayed work request content list as illustrated in FIG. 4B. In this case, the number of selected lists may be displayed (see 40).

The above-described input portion 120 may include, for example, a keyboard and a mouse.

Thereafter, the controller 130 may group at least two or more input work request contents according to classification criteria. The controller 130 may include a classification criteria extraction portion 131 and a grouping portion 132.

Specifically, the classification criteria extraction portion 131 of the controller 130 may extract classification criteria from each of at least two or more input work request contents.

Here, classification criteria may be for grouping work request contents, and may include a type of function requesting handling by a user.

Specifically, the type of function may include at least one of a first function for transmitting a handling result for the work request contents, a second function for moving to a page to enter information or to correct previously entered information, and a third function for detailed search on the work request contents.

Thereafter, the grouping portion 132 of the controller 130 may group two or more work request contents having the same classification criteria into a group based on the extracted classification criteria. Thereafter, the output portion 110 may display two or more work request contents having the same classification criteria for the group grouped by the grouping portion 132 in the form of user interface (UI) card.

Specifically, as for a status of receipt, the output portion 110 may display two or more work request contents 221a including a receipt request button 211 in the form of user interface (UI) card 221 as illustrated in FIG. 2C. Also, two or more work request contents 222a including an expected receipt date input button 212 may be displayed in the form of user interface (UI) card 222. Also, two or more work request contents 223a including an arrival date input button 213 may be displayed in the form of user interface (UI) card 223. In this case, classification criteria and the number of work request contents 224, 225, and 226 having the same classification criteria may be further displayed on an upper end.

Similarly, as for a task to be done, the output portion 110 may display two or more work request contents 321a including the request reception button 311 in the form of user interface (UI) card 321 as illustrated in FIG. 3C. Also, two or more work request contents 322a including a correction button 312 may be displayed in the form of user interface (UI) card 322. Also, two or more work request contents 323a including a detailed search button 313 may be displayed in the form of user interface (UI) card 323. Similarly, classification criteria and the number of work request contents 324, 325, and 326 having the same classification criteria may be further displayed on an upper end.

Finally, as for an email, the output portion 110 may display two or more work request contents 421a including an approval button 411 in the form of user interface (UI) card 421 as illustrated in FIG. 4C. Also, two or more work request contents 422a including the meeting acceptance button 312 may be displayed in the form of user interface (UI) card 422. Also, two or more work request contents 423a including a detailed search button 413 may be displayed in the form of user interface (UI) card 423.

Thereafter, when the user clicks the receipt request button 211 for implementing the first function, a batch handling indicator 241 for two or more work request contents having a receipt request function may be displayed as illustrated in FIG. 2D. Thereafter, when a user clicks the confirmation button 241a, the communication portion 150 may collectively transmit handling results for two or more work request contents (see 221a in FIG. 2C) having a receipt request function.

Similarly, when the user clicks the request reception button 211 for implementing the first function, a batch handling indicator 341 for two or more work request contents having a request reception function may be displayed as illustrated in FIG. 3D. Thereafter, when the user clicks the confirmation button 341a, the communication portion 150 may collectively transmit handling results for two or more work request contents (see 321a in FIG. 2C) having a request reception function.

When a user clicks the expected receipt date input button for implementing the second function, a page may move to a page 251 to enter the expected receipt date or to correct previously entered information as illustrated in FIG. 2E, and the user may enter information in each item 251a, 251b, and 251c of the page 251.

Similarly, when the user clicks the correction button 312 for implementing the second function, a page may move to a page 351 to correct previously entered information, or the user may correct previously entered information in each item 351a, 351b, and 351c of the page 351.

Meanwhile, the storage portion 140 may store the above-described work request content list, entered information, corrected information, and the like.

In example embodiments, the apparatus 110 may be included in, for example, a smart phone, a mobile phone, a laptop computer, a digital broadcasting terminal, a personal digital assistant (PDA), a portable multimedia player (PMP), a tablet PC, a desktop PC, and the like.

As described above, in an example embodiment, work request contents having the same function among work request contents selected by a user may be grouped and provided, such that work request contents having the same function may be swiftly identified.

Also, in an example embodiment, by collectively transmitting handling results for work request contents having a function for transmitting handling results for work request contents, work efficiency may be increased.

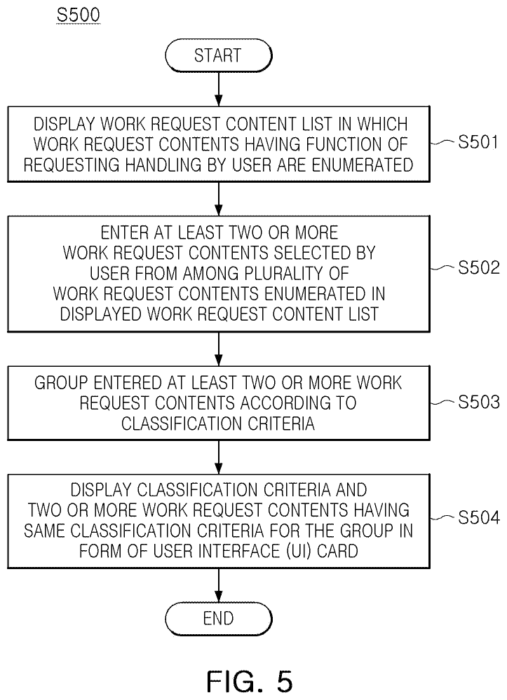

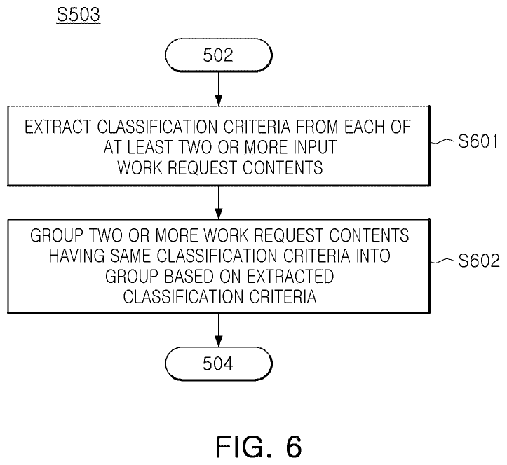

FIG. 5 is a flowchart illustrating a method for grouping work request contents selected from a work request content list according to an example embodiment. FIG. 6 is a flowchart illustrating operation 503 in FIG. 5.

Hereinafter, a method for grouping work request contents selected from a work request content list according to an example embodiment will be described with reference to FIGS. 1 to 6. However, for ease of the invention, the descriptions overlapping the descriptions described with reference to FIGS. 1 to 4C will not be provided.

Referring to FIGS. 1 to 5, a method for grouping work request contents selected from a work request content list according to an example embodiment may be initiated by an operation of displaying a work request content list in which work request contents having a function of requesting handling by a user are enumerated by the output portion 110 (S501). The work request contents and the work request content list may be as described above.

Thereafter, the input portion 120 may receive at least two or more work request contents selected by the user from among a plurality of work request contents enumerated in the work request content list displayed on the output portion 110 (S502).

Thereafter, the controller 130 may group at least two or more input work request contents according to classification criteria (S503).

Specifically, as illustrated in FIG. 6, the classification criteria extraction portion 131 of the controller 130 may extract classification criteria from each of at least two or more input work request contents (S601).

Here, the classification criteria may be for grouping work request contents, and may include the type of function requesting handling by a user as described above.

Specifically, the type of function may include at least one of a first function for transmitting the handling result for the work request contents, a second function for moving to a page to enter information or to correct previously entered information, and a third function for detailed search with respect to the work request contents, as described in the aforementioned example embodiment.

Thereafter, the grouping portion 132 of the controller 130 may group two or more work request contents having the same classification criteria into a group based on the extracted classification criteria (S602).

Thereafter, as illustrated in FIG. 5, the output portion 110 may display two or more work request contents having the same classification criteria for the group grouped by the grouping portion 132 in the form of user interface (UI) card (S504).

As described above, in an example embodiment, by grouping and providing work request contents having the same function selected by the user from among the work request contents, such that work request contents having the same function may be swiftly identified.

Also, according to an example embodiment, by collectively transmitting handling results for work request contents having a function for transmitting handling results for work request contents, work efficiency may be increased.

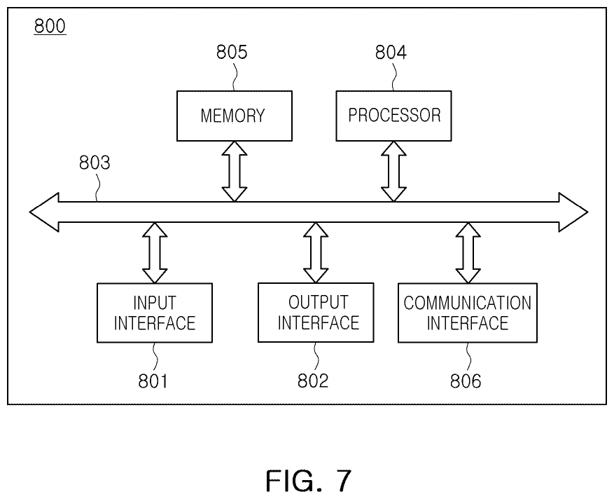

FIG. 7 is a block diagram illustrating a computer apparatus which may fully or partially implement an apparatus for grouping work request contents selected from a work request content list according to an example embodiment, and may be applied to the apparatus 100 for grouping work request contents selected from the work request content list illustrated in FIG. 1.

As illustrated in FIG. 7, a computer apparatus 700 may include an input interface 701, an output interface 702, a processor 704, a memory 705, and a communication interface 706, and the input interface 701, the output interface 702, the processor 704, the memory 705 and the communication interface 706 may be interconnected through a system bus 703.

In the example embodiment, the memory 705 may be used to store programs, instructions or codes, and the processor 704 may execute programs, instructions or codes stored in the memory 705, may receive signals by controlling the input interface 701, and may transmit signals by controlling the output interface 702. The memory 705 may include a read-only memory and a random access memory, and may provide instructions and data to the processor 704.

In the example embodiment, the processor 704 may be configured as a central processing apparatus (CPU), another general-purpose processor, a digital signal processor (DSP), an application specific integrated circuit (ASIC), a field programmable gate array (FPGA) or other programmable logic device, an individual gate or transistor logic device, an individual hardware component, and the like. The general-purpose processor may be implemented as a microprocessor, or the processor may be implemented as a general processor.

In an example embodiment, the method performed in the apparatus 100 in FIG. 1 may be performed by an integrated logic circuit of hardware in the processor 704 or an instruction in the form of software. The method described in the example embodiments may be implemented to be performed and completed by a hardware processor, or may be implemented to be completed by being performed by a combination of hardware and software modules of the processor. A software module may be disposed in a storage medium such as a random access memory, a flash memory, a read-only memory, a programmable read-only memory or an electrically erasable programmable memory, registers, or the like. The storage medium may be disposed in the memory 705, and the processor 704 may read information of the memory 705 and may combine the information with hardware to implement the above-described method. Overlapping detailed descriptions will not be provided.

Also, in the description, “. . . portion” may refer to various methods, for example, may be implemented by a processor, program instructions executed by the processor, a software module, a microcode, a computer program product, a logic circuit, an application-specific integrated circuit, firmware, and the like.

According to the aforementioned example embodiments, by grouping and providing work request contents with the same function among the work request contents selected by a user, work request contents having the same function may be identified swiftly.

By collectively transmitting handling results for work request contents having a function for transmitting handling results for work request contents, work efficiency may be increased.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for grouping work request contents selected from a work request content list, the apparatus comprising:
one or more processors; and
a memory storing instructions, wherein execution of the instructions configures the one or more processors to:
display a work request content list, the work request content list including work request contents associated with a function for requesting handling by a user are enumerated;
receive a user selection of two or more work request contents from among a plurality of work request contents enumerated in the displayed work request content list; and
group two or more selected work request contents according to a classification criteria.

2. The apparatus of claim 1, wherein the one or more processors are further configured to:
extract classification criteria from each of two or more of the selected work request contents; and
group two or more work request contents having a same classification criteria into a group based on the extracted classification criteria.

3. The apparatus of claim 2, wherein the classification criteria includes a type of function.

4. The apparatus of claim 3, wherein the type of the function includes one or more of a first function for transmitting a handling result for the work request contents, a second function for moving to a page to enter information or to correct previously entered information, and a third function for a detailed search with respect to the work request contents.

5. The apparatus of claim 3, wherein the function is implemented in a form of a button.

6. The apparatus of claim 4, wherein the one or more processors are further configured to:
collectively transmit handling results for two or more work request contents of the first function when the first function is performed.

7. The apparatus of claim 1, wherein the one or more processors are further configured to:
display the classification criteria and two or more work request contents having a same classification criteria in a form of user interface (UI) card with respect to groups of selected work request content.

8. A method for grouping work request contents selected from a work request content list, the method comprising:
displaying a work request content list including work request contents associated with a function for requesting handling by a user are enumerated;
receiving a selection of two or more work request contents from among a plurality of work request contents enumerated in the displayed work request content list; and
grouping two or more selected work request contents according to a classification criteria.

9. The method of claim 8, wherein the grouping comprises:
extracting the classification criteria from each of two or more selected work request contents by a classification criteria extraction portion; and
grouping two or more work request contents having a same classification criteria into a group based on the extracted classification criteria by a grouping portion.

10. The method of claim 9, wherein the classification criteria includes a type of the function.

11. The method of claim 10, wherein the type of the function includes one or more of a first function for transmitting a handling result for work request contents, a second function for moving to a page to enter information or to correct previously entered information, and a third function for a detailed search with respect to work request contents.

12. The method of claim 11, wherein the first function, the second function, and the third function are implemented in a form of a button.

13. The method of claim 11, further comprising:
collectively transmitting handling results for two or more work request contents of the first function when the first function is performed.

14. The method of claim 8, further comprising:
displaying the classification criteria and two or more work request contents having a same classification criteria in a form of user Interface (UI) card with respect to groups of selected work request content.

15. A processor-implemented method, the method comprising:
displaying a work request content list associated with a request to handle function of a plurality of functions;
receiving a selection of two or more work requests from the displaying of work requests in the work request content list; and
combining respective work requests of the selected two or more work requests according to a classification criteria.

16. The method of claim 15, wherein the plurality of functions include first functions for transmitting a handling result of the work request, second functions for editing information of the work request, and third functions for searching of the work request.

17. The method of claim 16, wherein the first functions include a receipt request function, an approval function, and a meeting accepted function.

18. The method of claim 15, further comprising:
displaying respective groups of the combined respective work requests with a respective criteria for the respective group.

19. The method of claim 15, further comprising:
extracting the classification criteria from the selection of two or more work requests.

20. The method of claim 19, wherein the combining further comprises:
forming groups of work requests based on a shared extracted classification criteria from the extracting.
